(19) United States
(12) Patent Application Publication
(10) Pub. No.: US 2017/0344434 A1
(43) Pub. Date: Nov. 30, 2017

(54) DOCKING DEVICE PROVIDING BACKUP TO MOBILE DEVICES AND METHOD FOR PROVIDING THE SAME

(71) Applicant: I/O INTERCONNECT, LTD., SANTA ANA, CA (US)

(72) Inventors: Gary KUNG, SANTA ANA, CA (US); Johnny Hsiang-Yu CHEN, TAIPEI CITY (TW)

(21) Appl. No.: 15/608,291

(22) Filed: May 30, 2017

Related U.S. Application Data
(60) Provisional application No. 62/343,025, filed on May 30, 2016.

(51) Int. Cl. G06F 11/14; G06F 1/26; G06F 3/06; H04M 1/725

(52) U.S. Cl. CPC G06F 11/1456; H04M 1/72527; G06F 1/26; G06F 3/061; G06F 3/0671

(57) ABSTRACT

Present disclosure relates to a docking device for providing backup to mobile devices and a method for providing the same. The docking device of present disclosure is connected between a computer and a storage device. The docking device comprises some ports to connect to a first mobile device and the storage device, wherein the docking device receives a first identity signal from the first mobile device and relays the first identity signal to the computer. A control unit of present disclosure is configured to relay the first identity signal to the computer and receives the first identity signal sent back to the first mobile device by the computer. A backup process is initiated to copy data from the first mobile device to the storage device when the first identity signal is sent back to the first mobile device.

### CROSS-REFERENCE TO RELATED APPLICATION

This application claims priority to U.S. Provisional Application Ser. No. 62/343,025, filed on May 30, 2016, which is herein incorporated by reference.

### BACKGROUND

### Field of Invention

The present disclosure relates to an interface device, and a method for operating the interface device. In particular, the present invention relates to a docking device for providing backup to mobile devices and a method for providing the same.

### Description of Related Art

Thanks to the improvements of USB technology, more and more interface devices are provided to people. However, most of current interface devices are passive devices provided as simple intermediates. None of them provides more smart or sophisticated services. Although there may have some software provided to associate with such an interface device, the service it may provide is still limited. Therefore, how to provide an active interface device that has smart or sophisticated services is a challenge to people in the art.

### SUMMARY

The disclosure provides a docking device connected between a computer and a storage device. The docking device comprises a plurality of ports and a control unit. The ports are configured to connect to a first mobile device and the storage device, wherein the docking device receives a first identity signal from the first mobile device and relays the first identity signal to the computer. The control unit is configured to determine whether the first mobile device is connected to one of the ports, wherein if the first mobile device is connected to one of the ports, the control unit delivers the first identity signal to the computer and receives the first identity signal sent back to the first mobile device by the computer, wherein the control unit initiates a backup process to copy data from the first mobile device to the storage device when the first identity signal is sent back to the first mobile device.

Another aspect of the disclosure is to provide a method employed on a docking device being connected with a computer and a storage device, wherein the method comprises: electrically connected a first mobile device and the storage device to a plurality of ports of the docking device; receiving a first identity signal from the first mobile device by the docking device; relaying the first identity signal to the computer by the docking device; determining, by a control unit of the docking device, whether the first mobile device is connected to one of the ports, wherein if the first mobile device is connected to one of the ports, the control unit delivers the first identity signal to the computer and receives the first identity signal sent back to the first mobile device by the computer; and initiating a backup process to copy data from the first mobile device to the storage device by the control unit when the first identity signal is sent back to the first mobile device.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a docking device according to some embodiments of the present disclosure;

FIG. 2 is a schematic diagram of a docking device according to some other embodiments of the present disclosure; and

FIG. 3 is a flow chart of a method for providing backup to mobile devices according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

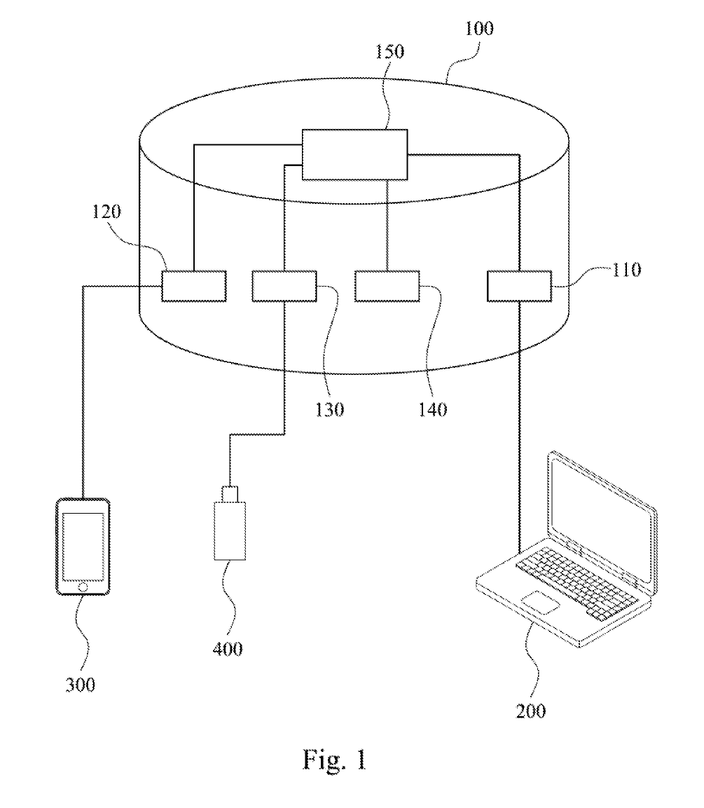

FIG. 1 is a schematic diagram of a docking device according to some embodiments of the present disclosure. As illustrated in FIG. 1, the docking device 100 includes a plurality of ports which are provided to connect to some peripheral devices. The ports include a first port 110, a second port 120, a third port 130 and a fourth port 140. The first port 110, the second port 120, the third port 130 and the fourth port 140 are electrically connected to a control unit 150.

In previous embodiment, a laptop 200 is connected to the docking device 100 via the first port 110, a mobile phone 300 is connected to the docking device 100 via the second port 120, and a USB flash drive 400 is connected to the docking device 100 via the third port 130. When the mobile phone 300 is connected to the docking device 100, the mobile phone 300 is triggered to send a first identity signal to the docking device 100. Since the mobile phone 300 is connected to the docking device 100 via the second port 120 and has already sent out the first identity signal. The control unit 150 delivers the first identity signal of the mobile phone 300 to the laptop 200 via the first port 110. When the laptop 200 receives the first identity signal, the control software on the laptop 200 recognizes the first identity signal and records the model of the mobile phone 300 according to the first identity signal. Then, the control unit 150 may also record the model of the mobile phone 300 according to the recognition of the laptop 200.

In some exemplary embodiment, control software for driving the control unit 150 is installed on the laptop 200 in the first place. When the mobile phone 300 is connected to the docking device 100, an automatic process is triggered by the laptop 200 for directing the mobile phone 300 to specific web pages (for example: Google Play or App store) to install the control software. The control software on the laptop 200 sends back the first identity signal to the mobile phone 300 through the docking device 100 as a response. When the mobile phone 300 receives the first identity signal being set back, the control software of the mobile phone 300 confirms the recognition is successful.

In previous embodiment, since the first identity signal is sent to the laptop 200 and sent back to the mobile phone 300, as an intermediate, the control unit 150 of the docking device 100 also receives the first identity signal sent from the laptop 200. Once the control unit 150 receives the first identity signal being sent back to the mobile phone 300, the control unit 150 initiates a backup process to copy data from the mobile phone 300 to the USB flash drive 400 automatically. The data from the mobile phone 300 may be directed to a specific folder prepared for the mobile phone 300 in the backup process. Of course, since the destination of the backup process is the USB flash drive 400, the backup process can only be initiated during the USB flash drive 400 is connected to the docking device 100.

In previous embodiment, when the mobile phone 300 is connected to the dock station 100 via the second port 120, the laptop 200 connected to the first port 110 would recognize the mobile phone 300 as an MTP (Media Transfer Protocol) drive. Since the first identity signal sent from the mobile phone 300 contains MTP drive information, it is possible for the laptop 200 to identify the given name and the product model of the mobile phone 300. The laptop 200 is therefore able to back up data from the mobile phone 300 via MTP drive to the specific folder prepared for the mobile phone 300 in the USB flash drive 400.

Furthermore, in some embodiments, when the mobile phone 300 is connected to the dock station 100 via the second port 120, the laptop 200 is able to turn the mobile phone 300 to ADK (Accessory Developer Kit) mode in order to check whether the mobile phone 300 is installed with the control software. Once the availability of the control software is confirmed, the control software of the mobile phone 300 sends the first identity signal to the docking device 100 by utilizing ADK protocol. Wherein the first identity signal may include the given name of the mobile phone 300, the product model of the mobile phone 300 or the data that required to be backed up. Therefore, the control software on the laptop 200 may directs the data to the specific folder prepared for the mobile phone 300 in the USB flash drive 400.

Moreover, in some embodiments, control software may be stored on the docking device 100. When the laptop 200 or the mobile phone 300 is connected to the docking device 100, the control software may be installed to the laptop 200 and/or the mobile phone 300. The establishment of the backup process is similar to the backup process according to previous embodiments.

The control software in aforementioned exemplary embodiments is installed to enhance the docking device 100 for providing additional operations to the mobile phone 300. Of course, if it is a tablet or other mobile device being connected to the docking device 100, corresponding operations can be provided by the docking device 100 as well.

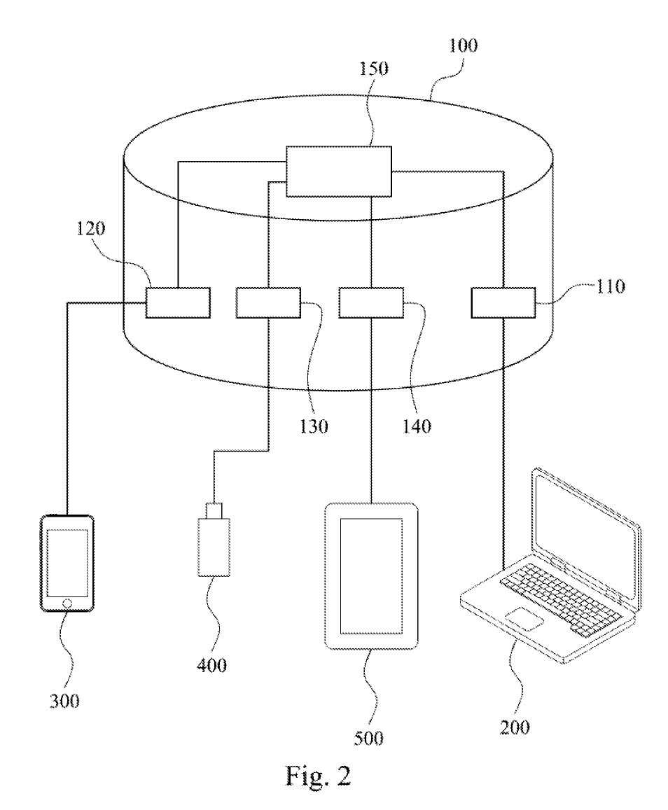

FIG. 2 is a schematic diagram of a docking device according to some embodiments of the present disclosure. In a modification of the foregoing embodiment, a tablet 500 is connected to the docking device 100 through the fourth port 140. The control software is installed to the tablet 500 by mentioned fashions in the exemplary embodiments. When the tablet 500 is connected to the docking device 100 via the fourth port 140, the tablet 500 is triggered to send a second identity signal to the docking device 100. Since the tablet 500 is connected to the docking device 100 via the fourth port 140 and has already sent out the second identity signal. The control unit 150 delivers the second identity signal of the tablet 500 to the laptop 200 via the first port 110. When the laptop 200 receives the second identity signal, the control software on the laptop 200 recognizes the second identity signal and records the model of the tablet 500 according to the second identity signal. Then, the control unit 150 may also record the model of the tablet 500 according to the recognition of the laptop 200. The control software on the laptop 200 sends back the second identity signal to the tablet 500 through the docking device 100 as a response. When the tablet 500 receives the second identity signal being set back, the control software of the tablet 500 confirms the recognition is successful.

In previous embodiment, since the second identity signal is sent to the laptop 200 and sent back to the tablet 500, the control unit 150 of the docking device 100 also receives the second identity signal sent from the laptop 200. Once the control unit 150 receives the second identity signal being sent back to the tablet 500, the control unit 150 initiates a backup process to copy data from the tablet 500 to the USB flash drive 400 automatically. The data from the tablet 500 may be directed to a specific folder prepared for the tablet 500 in the backup process. As such, when different mobile devices being connected to the docking device 100, the backup process would be initiated to copy data to corresponding zones in the USB flash drive 400.

The USB flash drive 400 in aforementioned embodiments is provided as an example rather than limitation, some possible storage devices such as other USB (Universal Serial Bus) flash drives, SD (Secure Digital) cards, HDD (Hard Disk Drive) or SSD (Solid State Disk) may also be connected to the docking device 100 as a destination of the backup process.

Furthermore, there are many fashions to assign one of the ports of the docking device 100 to the storage devices. In some embodiments, one of the ports of the docking device 100, the third port 130 for example, is marked and assigned as an exclusive port to be connected to the storage devices. The backup process may only be initiated when the USB flash drive 400 is connected to the third port 130 as a destination. In some embodiments, the software on the laptop 200 or the firmware on the docking device 100 may drive the control unit 150 to retrieve and store storage identity information from the USB flash drive 400, such as VID (Vendor ID) information or PID (Product ID) information. Afterward, whether the USB flash drive 400 is connected to any port of the docking device 100, from which port the control unit 150 retrieves the storage identity information of the USB flash drive 400, that port is assigned as the destination of the backup process. For example, whether the USB flash drive 400 is connected to the third port 130 or the fourth port 140, the backup process may be initiated. In some embodiments, a user may utilize the control software of the laptop 200 to assign any port of the docking device 100 as a destination in the backup process.

Furthermore, the user may utilize the control software of mobile phone 300 to specify which data required to be backed up. An index may be generated by the control unit 150 with respect to the data required to be copied to the USB flash drive 400 in the backup process. The data that required to be backed up are listed in the index according to their names, sizes, dates or other characteristics. The index is provided to the laptop 200 by the control unit 150, therefore the backup process may be held based on the index. In some cases, despite there was no control software installed on the mobile phone 300, the backup process may also be initiated according to the MTP protocol information sent form the mobile phone 300.

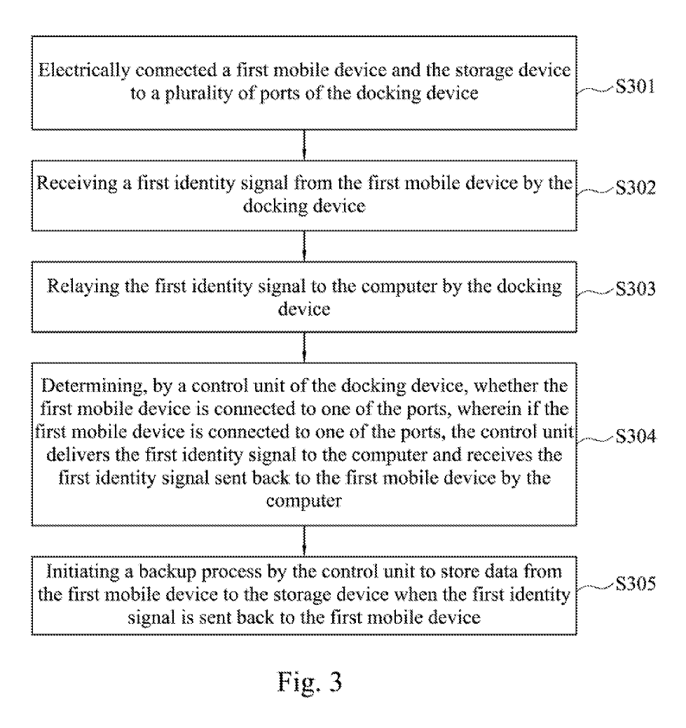

FIG. 3 is a flow chart of a method for providing backup to mobile devices according to some embodiments of the present disclosure. The steps of the method will be listed and explained in detail in following segments.

Step S301: Electrically connected a first mobile device and the storage device to a plurality of ports of the docking device. As illustrated in FIG. 1, in some embodiments, the mobile phone 300 is connected to the docking device 100 via the second port 120, the USB flash drive 400 is connected to the docking device 100 via the third port 130.

Step S302: Receiving a first identity signal from the first mobile device by the docking device. As illustrated in FIG. 1, in some embodiments, the mobile phone 300 sends the first identity signal to the docking device 100 via the second port 120, and the docking device 100 receives the first identity signal.

Step S303: Relaying the first identity signal to the computer by the docking device. As illustrated in FIG. 1, in some embodiments, the control unit 150 is configured to determine whether the mobile phone 300 is connected to one of the ports of the docking device 100 by checking the first identity signal. Since the mobile phone 300 is connected to the docking device 100 via the second port 120 and has already sent out the first identity signal. The control unit 150 relays the first identity signal of the mobile phone 300 to the laptop 200 via the first port 110.

Step S304: Determining, by a control unit of the docking device, whether the first mobile device is connected to one of the ports, wherein if the first mobile device is connected to one of the ports, the control unit delivers the first identity signal to the computer and receives the first identity signal sent back to the first mobile device by the computer. As illustrated in FIG. 1, in some embodiments, the first identity signal is sent to the laptop 200 and sent back to the mobile phone 300 via the docking device 100. As an intermediate, the control unit 150 of the docking device 100 has delivered first identity signal to the laptop 200 and receives the first identity signal sent from the laptop 200.

Step S305: Initiating a backup process by the control unit to copy data from the first mobile device to the storage device when the first identity signal is sent back to the first mobile device. As illustrated in FIG. 1, in some embodiments, when the control unit 150 receives the first identity signal being sent back to the mobile phone 300, the backup process is initiated by the control unit 150 to copy data from the mobile phone 300 to the USB flash drive 400. The data from the mobile phone 300 may be directed to a specific folder prepared for the mobile phone 300 in the backup process.

Moreover, since present disclosure is provided to support multiple mobile devices, when a second mobile device is connected to the docking device 100, aforementioned method may be employed correspondingly for backing up data from the second mobile device to the storage device being connected to the docking device 100.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A docking device, connected between a computer and a storage device, comprising:
a plurality of ports, configured to connect to a first mobile device and the storage device, wherein the docking device receives a first identity signal from the first mobile device and relays the first identity signal to the computer; and
a control unit, configured to determine whether the first mobile device is connected to one of the ports, wherein if the first mobile device is connected to one of the ports, the control unit delivers the first identity signal to the computer and receives the first identity signal sent back to the first mobile device by the computer, wherein the control unit initiates a backup process to copy data from the first mobile device to the storage device when the first identity signal is sent back to the first mobile device.

2. The docking device of claim 1, wherein the docking device receives a second identity signal from a second mobile device being connected to one of the ports and relays the second identification signal to the computer, wherein the control unit also initiates the backup process to copy data from the second mobile device to the storage device when the second identity signal is sent to the computer and being sent back to the second mobile device.

3. The docking device of claim 1, wherein the first identity signal includes MTP (Media Transfer Protocol) drive information.

4. The docking device of claim 1, wherein the first identity signal includes ADK (Accessory Developer Kit) protocol information.

5. The docking device of claim 1, wherein one of the ports is assigned to the storage device.

6. The docking device of claim 5, wherein one of the ports is assigned to the storage device by the computer.

7. The docking device of claim 1, wherein the control unit retrieves and stores storage identity information from the storage device, one of the ports from which the storage identity information being retrieved is assigned to the storage device afterward.

8. The docking device of claim 7, wherein the storage identity information includes VID (Vendor ID) information or PID (Product ID) information.

9. The docking device of claim 1, wherein the backup process includes full file backup or incremental file backup.

10. The docking device of claim 1, wherein the control unit generates an index with respect to the data being copied to the storage device in the backup process.

11. A method, employed on a docking device being connected with a computer and a storage device, comprising:
electrically connected a first mobile device and the storage device to a plurality of ports of the docking device;
receiving, by the docking device, a first identity signal from the first mobile device;
relaying, by the docking device, the first identity signal to the computer;
determining, by a control unit of the docking device, whether the first mobile device is connected to one of the ports, wherein if the first mobile device is connected to one of the ports, the control unit delivers the first identity signal to the computer and receives the first identity signal sent back to the first mobile device by the computer; and
initiating, by the control unit, a backup process to copy data from the first mobile device to the storage device when the first identity signal is sent back to the first mobile device.

12. The method of claim 11, further including:
receiving, by the docking device, a second identity signal from a second mobile device;
relaying, by the docking device, the second identity signal to the computer;
determining, by a control unit of the docking device, whether the second mobile device is connected to one of the ports, wherein if the second mobile device is connected to one of the ports, the control unit delivers the second identity signal to the computer and receives the second identity signal sent back to the second mobile device by the computer; and
initiating, by the control unit, the backup process to copy data from the second mobile device to the storage device when the second identity signal is sent back to the second mobile device.

13. The method of claim 11, wherein the first identity signal includes MTP (Media Transfer Protocol) drive information.

14. The method of claim 11, wherein the first identity signal includes ADK (Accessory Developer Kit) protocol information.

15. The method of claim 11, wherein one of the ports is assigned to the storage device.

16. The method of claim 15, wherein one of the ports is assigned to the storage device by the computer.

17. The method of claim 11, further including:
retrieving, by the control unit, storage identity information from the storage device;
storing, by the control unit, the identity information;
assigning, by the control unit, one of the ports from which the storage identity information is retrieved to the storage device.

18. The method of claim 17, wherein the storage identity information includes VID (Vendor ID) information or PID (Product ID) information.

19. The method of claim 11, wherein the backup process includes full file backup or incremental file backup.

20. The method of claim 11, further including:
generating, by the control unit, an index with respect to the data being copied to the storage device in the backup process.
